(19) United States
(12) Patent Application Publication
(10) Pub. No.: US 2010/0299745 A1
(43) Pub. Date: Nov. 25, 2010

(54) LOCKING AND RESETTING LOCK KEY OF COMMUNICATION DEVICE

(75) Inventors: Janne Henrik Karppinen, Lund (SE); Stefan Mikael Andersson, Klagerup (SE)

Correspondence Address: SNYDER, CLARK, LESCH & CHUNG, LLP, 950 Herndon Parkway, Suite 365, HERNDON, VA, 20170, US

(73) Assignee: Sony Ericsson Mobile Communications AB, Lund (SE)

(21) Appl. No.: 12/497,140

(22) Filed: Jul. 2, 2009

Related U.S. Application Data
(60) Provisional application No. 61/180,682, filed on May 22, 2009.

(51) Int. Cl. H04L 9/32; G06F 9/24

(52) U.S. Cl. 726/18; 713/2

(57) ABSTRACT

A device, such as a mobile phone, may include a memory to store a device-lock pass code. A processor in the device may compare the device-lock pass code stored in the memory to a device-lock pass code entered by a user to determine whether the entered device-lock pass code is correct. The processor may disallow use of the device when the entered device-lock pass code is not correct. The processor may reset the device-lock pass code stored in the memory when an entered unblock pass code is correct. Whether the unlock pass code is correct or not may be based on a comparison of the unblock pass code entered by the user to an unblock pass code associated with a removable identity module. In one embodiment, the memory in the device may include a boot module and an operating system. The memory may also include a memory area that stores the device-lock pass code. In one embodiment, the memory area is not accessible by the boot module, but may be accessed by the operating system.

### RELATED APPLICATIONS

This patent application claims priority under 35 U.S.C. § 119(e) to Provisional U.S. Patent Application No. 61/180,682, filed May 22, 2009, which is incorporated by reference herein.

### BACKGROUND

The “phone lock” feature found in mobile phones is intended to stop unauthorized use of the phones. Using this feature, the user of a mobile phone may select a code, which may include four of digits, for example. When activated, the phone lock feature prevents the mobile phone from being used without first entering the selected code during startup. If an authorized user forgets the code, however, the user may be prevented from his or her own phone. In this case, the user may reset the code, for example, with the help of a service center.

### SUMMARY

In one aspect, a device is provided that includes a memory and a processor. The memory may store a device-lock pass code. The processor may compare a device-lock pass code entered by a user to the device-lock pass code stored in the memory to determine whether the entered device-lock pass code is correct. The processor may disallow use of the device when the entered device-lock pass code is not correct. The processor may reset the device-lock pass code stored in the memory based on a comparison of an unblock pass code entered by the user to an unblock pass code associated with a removable identity module.

In another aspect, the memory may further include a boot module and an operating system, wherein the boot module includes instructions for execution by the processor before loading the operating system. The memory may further include a memory area not accessible by the boot module. The memory area may be accessible by the operating system and the memory area may store the device-lock pass code.

In another aspect, the memory area may not be accessible by software executed by a processor external to the device. The memory area may also not be accessible by loader code.

In another aspect, the processor may be configured to receive an indication, from the removable identity module, of whether the unblock pass code entered by the user is correct based on the comparison of the pass code entered by the user with the unblock pass code associated with the removable identity module.

In another aspect, the processor may be configured to allow use of the device by the user when the entered device-lock pass code is correct. The processor may be configured to allow use of the device when the entered device-lock pass code is correct and the removable identity module associated with the stored device-lock pass code is present in the device.

In another aspect, the processor may be configured to disallow use of the device when the entered device-lock pass code is correct and the associated removable identity module is not present in the device.

In another aspect, the processor may be configured to disallow use by disallowing access to user application data, contact information, calendar information, text messages, email messages, user documents, or web-browsing history. The processor may also be configured to disallow use by disallowing placing or receiving a telephone call.

In one aspect, a computer-implemented method is provided. The method may include comparing a device-lock pass code entered by a user to a device-lock pass code stored in a memory of a user device to determine whether the entered device-lock pass code is correct and disallowing use of the user device when the entered device-lock pass code is not correct. The method may include determining whether an unblock pass code entered by the user is correct based on a comparison of the unblock pass code entered by the user to an unblock pass code stored in and associated with the user device and resetting the device-lock pass code stored in the memory of the user device when the entered unblock pass code is correct. The method may include storing a copy of the unblock pass code in a memory device capable of being removably connected to the user device or in a memory of another user device separate from the user device.

In another aspect, the method may include storing the unblock pass code associated with the user device in a non-removable memory in the user device. The entered device-lock code may be entered by connecting the memory device to the user device, and the unblock pass code entered by the user to the unblock pass code stored in and associated with the user device includes comparing the copy of the unblock pass code to the unblock pass code stored in and associated with the user device.

In another aspect, the method may include allowing use of the user device by the user when the entered device-lock pass code is correct. The method may include allowing use of the user device by the user when the entered device-lock pass code is correct and a removable identity module associated with the stored device-lock pass code is present in the user device.

In another aspect, the method may include disallowing use of the user device when the entered device-lock pass code is correct and the associated removable identity module is not present in the user device.

In another aspect, the method disallowing access to user application data, contact information, calendar information, text messages, email messages, user documents, or web-browsing history; and disallowing placing or receiving a telephone call.

In another aspect, the method may include disallowing access to user application data, contact information, calendar information, text messages, email messages, user documents, or web-browsing history. The method may include disallowing placing or receiving a telephone call.

In one aspect, a device having a processor and a memory is disclosed. The memory may include a boot module and an operating system. The boot module may include instructions for execution by the processor before loading the operating system. The memory may include a memory area not accessible by the boot module. The memory area may store a first pass code and may be accessible by the operating system. The processor may compare a pass code entered by a user to the first pass code stored in the memory area to determine whether the pass code entered by the user is correct. The processor may disallow use of the device when the pass code entered by the user is not correct.

In another aspect, the memory area may not be accessible by software being executed by a processor external to the device. The memory area may not be accessible by loader code.

In another aspect, the first pass code stored in the memory area may be associated with a removable identity module. The processor may be further configured to disallow use of the device when the entered code is correct and the removable identity module is not present in the device.

In another aspect, the processor may be configured to allow use of the device by the user when the pass code entered by the user is correct, or allow use of the device by the user when the pass code entered by the user is correct and the removable identity module associated with the first pass code is present in the device.

In another aspect, the processor may be configured to disallow use by being configured to disallow access to user application data, contact information, calendar information, text messages, user email messages, user documents, web-browsing history, or a user application.

In another aspect, the processor may be configured to disallow use by being configured to disallow placing or receiving a telephone call.

In another aspect, the processor may be configured to reset the first pass code stored in the memory area based on a comparison of the other pass code entered by the user to a second pass code associated with the removable identity module.

In another aspect, the second pass code associated with the removable identity module may be stored in the removable identity module. The removable identity module may include a processor configured to compare the other pass code entered by the user to the second pass code associated with the removable identity module to determine whether the entered unblock pass code is correct.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 is a block diagram of an exemplary environment in which embodiments disclosed herein may be implemented;

FIG. 2 is a block diagram of an exemplary environment for setting, changing, and resetting phone/subscriber-identity-module (SIM) key (PSK) codes for locking a user device;

FIG. 3 is a diagram of an exemplary user device that may implement embodiments described herein;

FIG. 4 is a block diagram of exemplary components of a client computing module;

FIGS. 5A, 5B, and 5C are block diagrams of exemplary components of the memory of the client computing device of FIG. 4;

FIG. 6 is a block diagram of exemplary components of a server computing module;

FIGS. 7, 8, 9A, and 9B are flowcharts of exemplary processes for setting, changing, and resetting PSK codes for locking the user device of FIG. 2;

FIGS. 10A, 10B, and 10C are diagrams of exemplary exchanges of information between the devices of the network of FIG. 2 for the processes of FIGS. 7, 8, 9A, and 9B;

FIG. 11 is a diagram of exemplary user interfaces that a user may encounter during the processes of FIGS. 7, 8, 9A, and 9B;

FIGS. 12 and 14 are flowcharts of additional exemplary processes for resetting the PSK code for locking the user device of FIG. 2; and

FIGS. 13 and 15 are diagrams of exemplary exchanges of information between the devices of the network of FIG. 2 for the processes of FIGS. 12 and 14.

### DETAILED DESCRIPTION

The following detailed description refers to the accompanying drawings. The same reference numbers in different drawings may identify the same or similar elements.

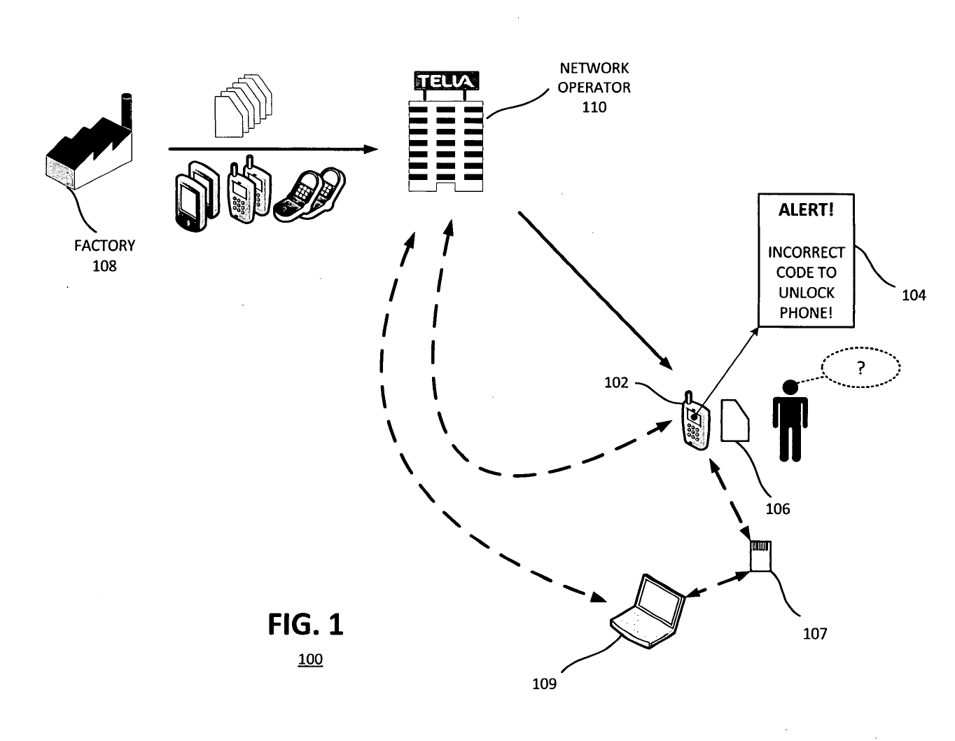

FIG. 1 is a block diagram of an exemplary network 100 in which embodiments described herein may be implemented. Network 100 may include a mobile phone 102 including a Subscriber identity Module (SIM) card 106. In the example of FIG. 1, the user locked his mobile phone 102 to prevent the mobile phone 102 from being used without (1) first entering the a pass code (e.g., selected by the user) during startup and (2) having a particular SIM card (associated with the pass code) in the mobile phone. In one embodiment, to enhance the security of the pass code selected by the user, it may be stored in a memory in mobile phone 102 that is not accessible by code other than the operating system of the phone (e.g., not accessible by boot module code or loader code).

The user in the example of FIG. 1, however, has forgotten the pass code to unlock the phone. As shown, a display 104 of mobile phone 102 indicates to the user that he has entered the wrong pass code to unlock the phone. In embodiments disclosed herein, a network operator 110 may provide the user with a personal unlock (PUK) code associated with the SIM card or a device unlock (DUK) code associated with mobile phone 102. The PUK code and/or DUK code may allow the user to reset the pass code stored in the memory of mobile phone 102. In one embodiment, the PUK code or the DUK code may be stored in removable memory 107. In another embodiment, the DUK code may be downloaded by the user (using computer 109) from the network operator 110 after authentication of the user.

In some embodiments, factory 108 manufactures SIM card 106 and mobile phone 102. In this embodiment, factory 108 may provide the PUK codes and DUK codes to network operator 110. In another embodiment, SIM cards may be manufactured in a different factory than the phones. In this embodiment, the SIM card factory may provide the PUK codes to network operator 110 and a phone factory may provide the DUK codes to network operator 110.

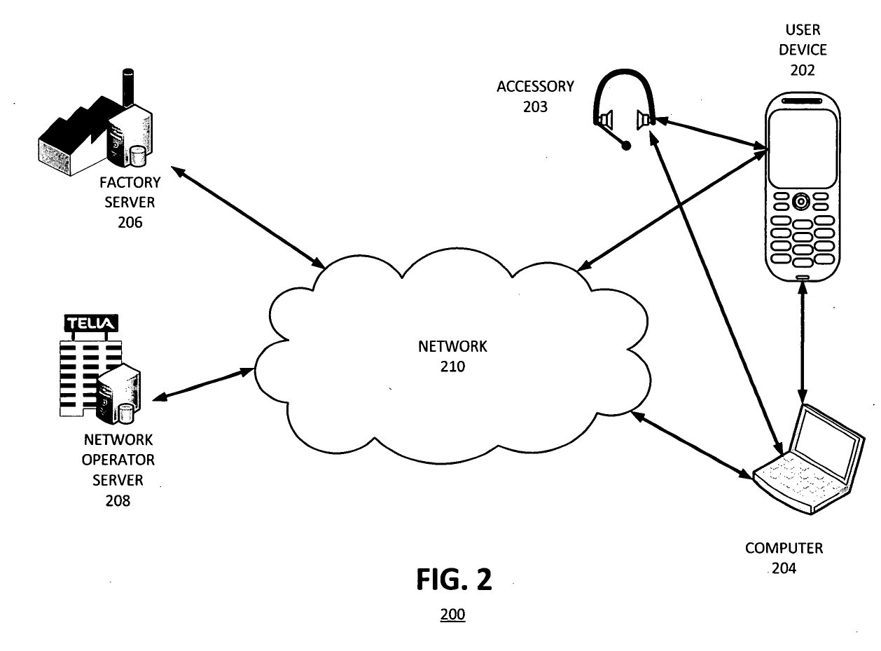

FIG. 2 is a block diagram of an exemplary network 200 for setting, changing, and resetting phone/SIM key (PSK) codes for locking a user device. Network 200 may include a user device 202, an accessory 202, a computer 204, a factory server 206, a network operator server 208, and a network 210. Network 210 may allow all the devices in network 200 to communicate with each other.

User device 202 may include a mobile device, such as a mobile phone, PDA, etc., that allows users to initiate or receive telephone calls or send messages to other user devices, such other mobile phones or laptop computers 204. User device 202 may communicate with other devices via base transceiver stations (BTSs, not shown) using a wireless communication protocols, e.g., GSM (Global System for Mobile Communications), CDMA (Code-Division Multiple Access), WCDMA (Wideband CDMA), GPRS (General Packet Radio Service), EDGE (Enhanced Data Rates for GSM Evolution), etc. In one embodiment, user device 202 may communicate with other devices using wireless network standards such as WiFi (e.g., IEEE 802.11x) or WiMAX (e.g., IEEE 802.16x). In yet another embodiment, user device 202 may communicate with other devices via a wired network using, for example, a public-switched telephone network (PSTN) or an Ethernet network.

Accessory 203 may include a wired or wireless headset, a digital photo frame, a display, a speaker, etc., for outputting audio, pictures, video, etc. Accessory 203 may receive files (e.g., music, pictures, video, etc.) from other user devices, such as user device 202 or computer 204. Further, accessory 203 may send these files to other devices, such as user device 202 or computer 204. Accessory 203 may communicate with other devices using a wireless communication protocol (e.g., Bluetooth, WiFi, or WiMAX) or a cable (e.g., a Universal Serial Bus (USB) cable or a Serial bus (RS-232) cable).

Computer 204 may include one or more computer systems for hosting programs, databases, and/or applications. Computer 204 may include a laptop, desktop, notebook, netbook, internet tablet or any other type of computing device. Computer 204 may include client application programs, such as a browser application (e.g., Mozilla Firefox) program for navigating a network, such as the Internet or network 210 to accessing information stored in, for example, factory server 206.

Factory server 206 and operator server 208 may include one or more computer systems for hosting programs, databases, and/or applications. For example, servers 206 and 208 may include server software such as a web server for delivering web pages and interacting with users of user device 202 or computer 204. Servers 206 and 208 may include a database application (e.g., MySQL) for storing data related to a large number of user devices, such as user device 202, and their associated users.

Network 210 may include one or more wired and/or wireless networks that may receive and transmit data, sound (e.g., voice), or video signals. Network 210 may include one or more BTSs (not shown) for transmitting or receiving wireless signals to/from mobile communication devices, such as devices 104-108, using wireless protocols (e.g., GSM, CDMA, WCDMA, GPRS, EDGE, etc.). Network 210 may further include one or more packet switched networks, such as an Internet protocol (IP) based network, a local area network (LAN), a wide area network (WAN), a personal area network (PAN), a virtual private network (VPN), or another type of network that is capable of carrying data. Network 210 may also include one or more circuit-switched networks, such as a PSTN.

The exemplary configuration illustrated in FIG. 2 is provided for simplicity. In other embodiments, network 200 may include more, fewer, or different devices. Network 200 may also include thousands, if not hundreds of thousands, of user devices and computers, such as devices 202-208. Moreover, one or more devices 202-208 may perform one or more functions of any other device in network 200.

Although FIG. 2 shows devices 202-208 coupled to network 210 in a particular configuration, these devices may also be arranged in other configurations, either coupling directly with each other or through one or more networks, such that any one of devices 202-208 may communicate with any other one of devices 202-208. For example, in one embodiment, user device 202 may communicate with computer 204 via wireless signals (e.g., Bluetooth) or a cable (e.g., a USB or an RS-232 cable).

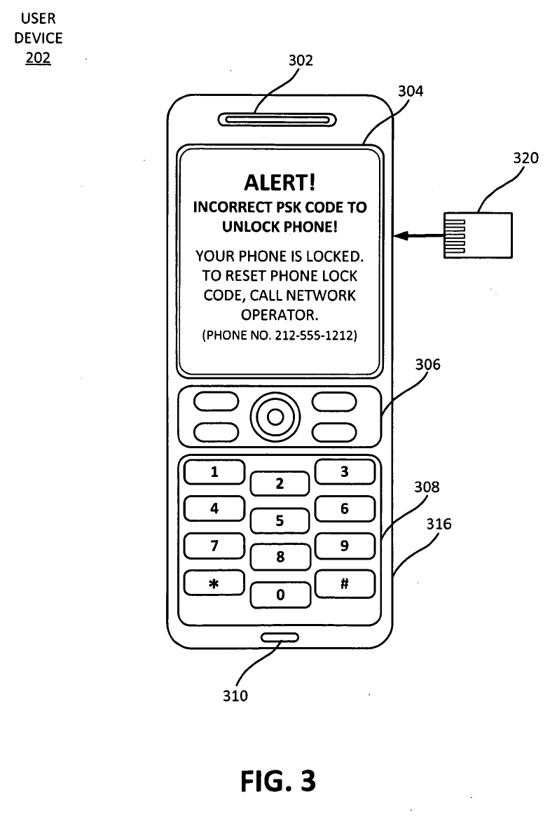

FIG. 3 is a diagram of an exemplary user device 202 that may implement embodiments described herein. Although device 202 is depicted as a mobile phone and may be referred to below as “mobile phone 202,” device 202 may include any of the following devices: a mobile telephone; a desktop, laptop, notebook, netbook, or personal computer; a personal digital assistant (PDA); a gaming device or console; a personal music playing (PMP) device; a Global Positioning System (GPS) device; a digital camera; or another type of computational or communication device.

As shown in FIG. 3, device 202 may include a speaker 302, a display 304, control keys 306, a keypad 308, a microphone 310, a housing 316, and a removable memory card 320. Speaker 302 may provide audible information to a user of device 202. Display 304 may provide visual information to the user, such as the image of a caller, text, menus, video images, or pictures. Control keys 306 may permit the user to interact with device 202 to cause it to perform one or more operations, such as place or receive a telephone call. Keypad 308 may include a numeric, alphanumeric, and/or telephone keypad. Microphone 310 may receive sound, e.g., the user's voice during a telephone call.

Removable memory card 320 may store applications and/or data files, such as pass codes, music, or video. When removable memory card 320 is inserted into user device 202, user device 202 may read the data files or execute the applications, for example. In another embodiment, removable memory card 320 may be connected to user device 202 without inserting it into user device 202, e.g., it may be connected externally as with a USB memory device.

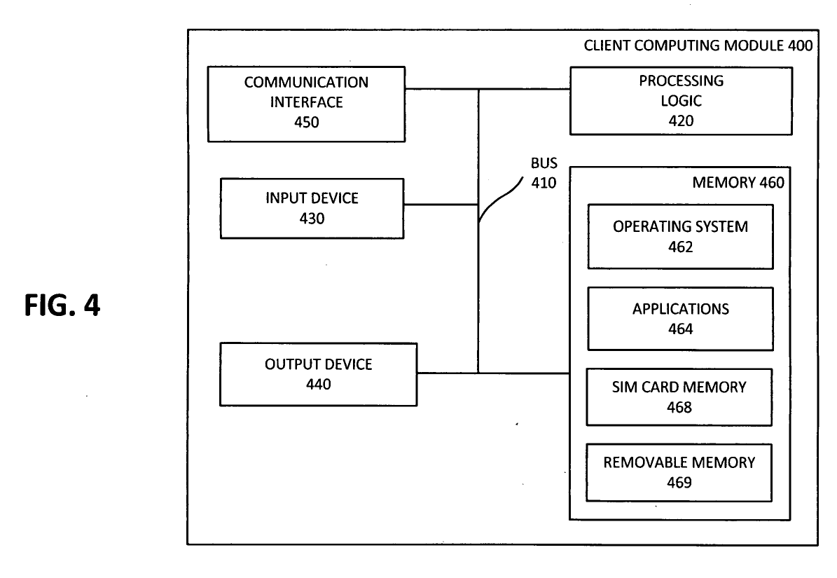

FIG. 4 is a block diagram of exemplary components of a client computing module 400. User device 202 and computer 204 may each include one or more computing modules 400. Client computing module 400 may include a bus 410, processing logic 420, an input device 430, an output device 440, a communication interface 450, and a memory 460. Client computing module 400 may include other components (not shown) that aid in receiving, transmitting, and/or processing data. Moreover, other configurations of components in client computing module 400 are possible.

Bus 410 may include a path that permits communication among the components of client computing module 400. Processing logic 420 may include any type of processor or microprocessor (or groups of processors or microprocessors) that interprets and executes instructions. In other embodiments, processing logic 420 may include one or more application-specific integrated circuits (ASICs) or field-programmable gate arrays (FPGAs).

Input device 430 may include a device that permits a user to input information into client computing module 400, such as a keyboard (e.g., control keys 306 or keypad 308), a mouse, a pen, a microphone (e.g., microphone 310), a camera, a touch-screen display (e.g., display 304), etc. Output device 440 may output information to the user, such as a display (e.g., display 304), a speaker (e.g., speaker 302), etc. Input device 430 and output device 440 may allow the user to receive and view a menu of options and select from the menu options. The menu may allow the user to select the functions or services associated with applications executed by client computing module 400.

Communication interface 450 may include a transceiver that enables client computing module 400 to communicate with other devices or systems. Communications interface 450 may include a network interface card, e.g., Ethernet card, for wired communications or a wireless network interface (e.g., a WiFi) card for wireless communications. Communication interface 450 may implement a wireless communication protocol, e.g., GSM, CDMA, WCDMA, GPRS, EDGE, etc. Communication interface 450 may also include, for example, a universal serial bus (USB) port for communications over a cable, a Bluetooth™ wireless interface for communicating with Bluetooth devices, a near-field communication (NFC) interface, etc.

Memory 460 may include a random access memory (RAM) or another type of dynamic storage device that may store information and instructions, e.g., an application, for execution by processing logic 420; a read-only memory (ROM) device or another type of static storage device that may store static information and instructions for use by processing logic 420; or some other type of magnetic or optical recording medium and its corresponding drive, e.g., a hard disk drive (HDD), a solid state drive (S SD) or memory, for storing information and/or instructions.

Memory 460 may also include an operating system 462 and applications 464. Operating system 462 may include software instructions for managing hardware and software resources of the device. In the case of user device 202, operating system 462 may include Symbian, Android, Windows Mobile, etc. In the case of computer 204, operating system 462 may include Linux, Apple OS X, or Microsoft Windows. Applications 464 may provide services to the user of the device, such as, for example, a browser for browsing the Internet.

Memory 460 may also include a SIM card memory 468 and a removable memory device 469. SIM card memory 468 may be inserted into computing module 400 for identifying the computing module in a GSM or other network. Other types of identity devices are possible other than a SIM card. For example, any type of removable user identity module is possible, such as R-UIM (Removable User Identity Module), which is common in Interim Standard 95 (IS-95 or cdmaOne) or CDMA2000 standard phones that employ code division multiple access (CDMA) channels. Removable memory 469 may include removable memory card 320 shown in FIG. 3 and described above. As used herein, “a removable identity module” may refer to a SIM, an R-UIM, or any such device. FIG. 4 shows SIM card memory 468 included in memory 460. In some embodiments, the SIM card may itself include a computing module, similar to computing module 400, e.g., with processing logic, a communication interface, as well as memory.

Client computing module 400 may perform operations, as described herein, in response to processing logic 420 executing software instructions store in a computer-readable medium, such as memory 460. A computer-readable medium may include a physical or logical memory device. The software instructions may be read into memory 460 from another computer-readable medium or from another device via communication interface 450. The software instructions contained in memory 460 may cause processing logic 420 to perform processes that are described below.

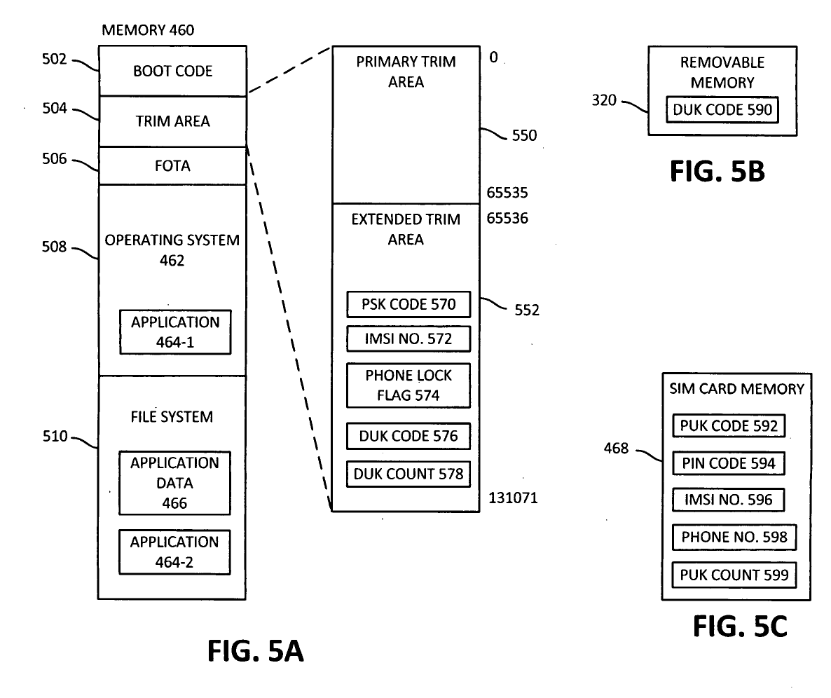

FIG. 5A is a block diagram of an exemplary memory map of memory 460 of client computing module 400. As shown, memory 460 may include boot module code area 502, a trim area 504, a firmware over-the-air (FOTA) area 506, an operating system area 508, and a files system area 510. Other areas of memory are possible, but not shown in FIG. 5A.

Boot module code area 502 may include bootstrap loading code (“boot module code”) to load operating system 462 stored in operating system area 508 for execution by user device 202. The boot module code may also execute code before loading operating system 462. As used herein, a “boot module” or “boot module code” refers to instructions run by user device 202 before loading operating system 462 stored in operating system area 508. For example, the boot module code may prompt the user for a password, code, or pass code (e.g., a personal identification number (PIN) code) before loading operating system 462. In this embodiment, the entered PIN may be compared to a PIN stored in SIM card memory 468, as further described below.

FOTA area 506 may be used to wirelessly download and store a loader and/or firmware updates from a BTS, for example. The boot module code and/or loader may install updated firmware into operating system area 508. As such, the terms “boot module” or “boot module code” may also refer to the code for updating the firmware in operating system area 508, as this code is also run by user device 202 before loading the updated operating system.

Operating system area 508 may include operating system 462 that may be loaded by code stored in boot module code area 502 for using mobile phone 202 as a phone. File system 510 may store applications (e.g., application 464-2) and application data 466. In addition, an application 464-1 may be stored with operating system 462 in operating system area 508.

Trim area 504 may include a primary trim area 550 (e.g., memory units 0 to 65535=2¹⁶) and an extended trim area 552 (e.g., memory units 65536=2¹⁶ to 131071=2¹⁷). Primary trim area 550 includes memory accessible (e.g., addressable) by code stored in boot module code area 502. In one embodiment, extended trim area 552 may include memory that is not accessible (e.g., addressable) by one or more or all of (1) boot module code; (2) a loader that may be downloaded, for example, during a firmware update; or (3) by software tools or components running, for example, in computer 204 that may be coupled user device 202 (e.g., computing module 400). In one embodiment, extended trim area 552 may include memory accessible by operating system 462 stored in operating system area 508 and applications running in operating system 462. In one embodiment, extended trim area 552 is only accessible by operating system 462.

As shown in FIG. 5A, extended trim area 552 may include a phone/SIM key (PSK) code area 570, an International Mobile Subscriber Identity (IMSI) number area 572, a phone lock flag area 574, a device unlock key (DUK) code area 576, and a DUK count area 578. Although FIG. 5A is a memory map, the relative positions of memory areas 570-578 do not necessarily indicate their relative addresses in memory 460.

PSK code area 570 may store a value indicative of a PSK code for unlocking the user device. For example, the true owner of a mobile phone may choose to lock a mobile phone with a PSK code. In this embodiment, only the true owner (i.e., any user knowledgeable of the PSK code) can power on and operate the mobile phone because only the true owner will know the PSK code (stored in PSK code area 570) when prompted to enter it by the mobile phone. In addition, the PSK code may be associated with the SIM card in the mobile phone at the time the PSK code was generated and stored in PSK code area 570. In this embodiment, the mobile phone cannot be used (even by someone knowledgeable of the PSK code) if the SIM card has been changed. In one embodiment, the factory-set default value for the PSK code stored in PSK code area 570 is 0000.

IMSI number area 572 may store a number indicative of a unique identity of the SIM card in the device that corresponds to PSK code stored in PSK code area 570. As described above, in one embodiment, the device may only be unlocked not only when the correct PSK code is entered by the user, but also when the SIM card that corresponds to value stored in PSK code area 570 is in the user device.

Phone lock flag area 574 may store an indication (e.g., TRUE or FALSE) regarding whether the value stored in a PSK code area 570 is currently being used to lock the phone. In one embodiment, the factory-set default value stored in phone lock flag area 574 is FALSE.

DUK code area 576 may store a value indicative of a DUK code for unlocking (e.g., unblocking) a user device and resetting the PSK code indicated in PSK code area 570 when, for example, the user does not remember the PSK code. DUK count area 578 may count the number of times a user incorrectly enters a DUK code. In one embodiment, when the value in DUK count area 578 reaches a certain number, the phone may become unusable.

In one embodiment, PSK code area 570 may store the hash value of the PSK code. Further, IMSI number area 572 may store the hash of the IMSI number associated with the PSK code. Additionally, DUK code area 576 may store the hash of the DUK code. In this embodiment, the user device may compare the value stored in PSK code area 570 to the hash of the PSK code entered by the user, for example, to determine whether the entered PSK code is correct. Likewise, the user device may compare the value stored in IMSI number area 572 in extended trim area 552 to the hash of the IMSI number stored in IMSI number area 596 of SIM card memory 468 to determine whether the SIM card in the user device is the SIM card associated with the correct PSK code. Further, the user device may compare the value stored in DUK code area 576 with a hash of the value entered by the user to determine whether the entered DUK code is correct. Comparisons of pass codes (e.g., entered/stored PSK and/or DUK codes) may be performed by processing logic 420 in client computing module 400.

In one embodiment, if the hash of the IMSI number is stored in IMSI number area 572, the hash may be keyed by the PSK code. For example, the IMSI number may be concatenated with or extended by the PSK code before hashing. Likewise, if the hash of the PSK code is stored in PSK code area 570, the hash may be keyed by the IMSI number. This embodiment may allow detection of a change in the PSK code area 570 without a corresponding change in the IMSI number area 572 and vice versa. Alternatively, the PSK code and the IMSI number may be concatenated, hashed, and stored without having separate PSK code area 570 and IMSI number area 572.

FIG. 5B is a block diagram of components of removable memory 320. In one embodiment, removable memory 320 may include a DUK code area 590 for storing the DUK code. In this embodiment, the DUK code stored in DUK code area 590 may be compared to the DUK code stored in DUK code area 576. If the same, then the user may reset the PSK code stored in PSK code area 570 if requested.

FIG. 5C is a block diagram of components of SIM card memory 468. SIM card memory 468 may include a personal unlock key (PUK) code area 592, a PIN code area 594, an IMSI number area 596, a phone number area 598, and a PUK count area 599.

Personal unlock key (PUK) code area 592 may store a code for unlocking (e.g., unblocking) a user device and resetting the PSK code stored in PSK code area 570 when, for example, the user does not remember the PSK code. PIN code area 594 may store a code for enabling a user device to operate with the corresponding SIM card. In one embodiment, PUK code area 592 and/or PIN code area 594 may store hash values of codes. IMSI number area 596 may store the IMSI number associated with the SIM card (e.g., the unique identity of the SIM card). Phone number area 598 may store the phone number associated with the IMSI number and the SIM card.

PUK count area 599 may store a count of the number of times a user incorrectly enters a PUK code. In one embodiment, when the value in PUK count area 599 reaches a certain number, the SIM card having SIM card memory 468 may become unusable (e.g., blocked) and the phone locked with a PSK code associated with the SIM card may also be unusable. Whether the user correctly enters a PUK code or mot may be based on a comparison of codes (e.g., entered/stored PUK codes) that are performed by processing logic on the SIM card in the user device. As with PSK codes, comparing PUK codes entered by the user to the PUK code stored in PUK code area 592 may include hashing the PUK code entered by the user and comparing it to a hash of a PUK code stored in PUK code area 592.

The codes stored in PUK code area 592, PIN code area 594, PSK code area 570, and DUK code 576 may all be referred to as “pass codes” and may include any type or number of characters, including alphabetic symbols, numeric symbols, alphanumeric symbols, or other characters. In one embodiment, these pass codes include only numbers, e.g., four digits.

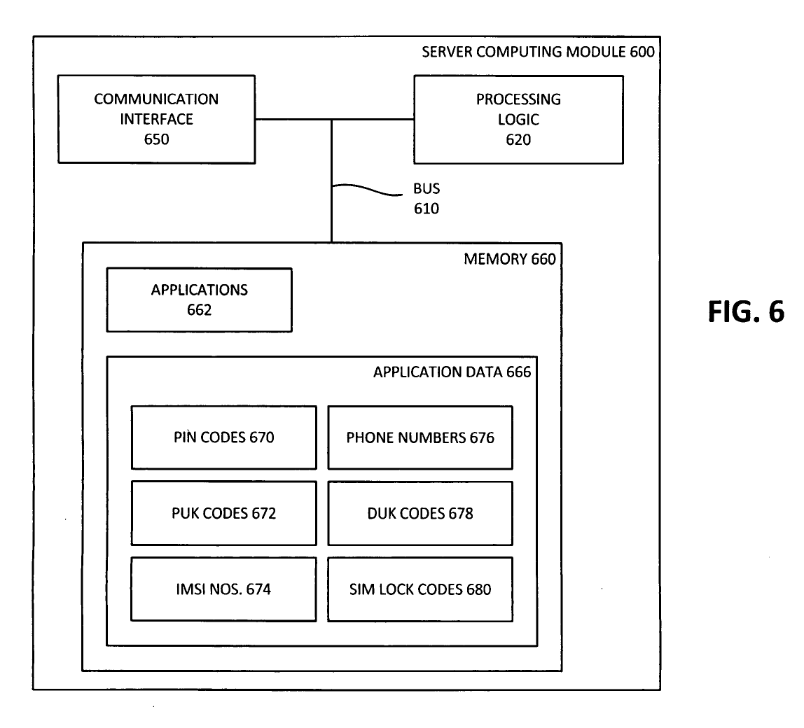

FIG. 6 is a block diagram of exemplary components of a server computing module 600. Factory server 206 and operator server 208 may include one or more server computing modules (e.g., a rack of server computer modules), such as computing module 600. Server computing module 600 may include a bus 610, processing logic 620, a communication interface 650, and a memory 660. Server computing module 600 may include other components (not shown) that aid in receiving, transmitting, and/or processing data. Moreover, other configurations of components in module 600 are possible.

Bus 610 may include a path that permits communication among the components of module 600. Processing logic 620 may include any type of processor or microprocessor (or groups of processors or microprocessors) that interprets and executes instructions. In other embodiments, processing logic 620 may include one or more ASICs or FPGAs or the like.

Communication interface 650 may include a transceiver that enables module 600 to communicate with other devices or systems. Communications interface 650 may include a network interface card, e.g., Ethernet card, for wired communications or a wireless network interface (e.g., a WiFi card) for wireless communications.

Communication interface 650 may also include, for example, a USB port for communications over a cable, a Bluetooth wireless interface for communicating with Bluetooth devices, a NFC interface, etc. Communication interface 650 may implement a wireless communication protocol, e.g., GSM, CDMA, WCDMA, GPRS, EDGE, etc. Communication interface 650 may be coupled to an antenna for transmission and reception of signals.

Memory 660 may include a RAM or another type of dynamic storage device that may store information and instructions, e.g., an application that may be executed by processing logic 620 and application data. Memory 660 may include a ROM device or another type of static storage device that may store static information and instructions for use by processing logic 620; and/or some other type of magnetic or optical recording medium, e.g., a HDD or SSD, for storing information and/or instructions.

Memory 660 may include applications 662 and application data 666. Applications 662 may include a database application, such as MySQL. Application data 666 may include a database of information related to user devices (e.g., mobile phones), SIM cards, and users. For example, application data 666 may identify and associate PIN codes 670, PUK codes 672, IMSI numbers 674, phone numbers 676, DUK codes 678, and SIM lock codes 680.

For example, when factory 108 (see FIG. 1) manufactures SIM cards, it may store the PIN code, PUK code, and IMSI number for each SIM card in factory server 206. This information (670, 672, and 674) may be sent through network 210 to operator server 208 at network operator 110. Network operator 110 may then associate a phone number with each SIM card (e.g., creating data for phone numbers 676). When factory 108 manufactures user devices (e.g., mobile phones), it may store the DUK code and SIM lock code for each user device in factory server 206. This information (678 and 680) may then be sent through network 210 to operator server 208 at network operator 110.

Module 600 may perform certain operations, as described in detail below, in response to processing logic 620 executing software instructions stored in a computer-readable medium, such as memory 660. The software instructions may be read into memory 660 from another computer-readable medium or from another device via communication interface 650. The software instructions contained in memory 660 may cause processing logic 620 to perform processes that are described below.

### Exemplary Processes

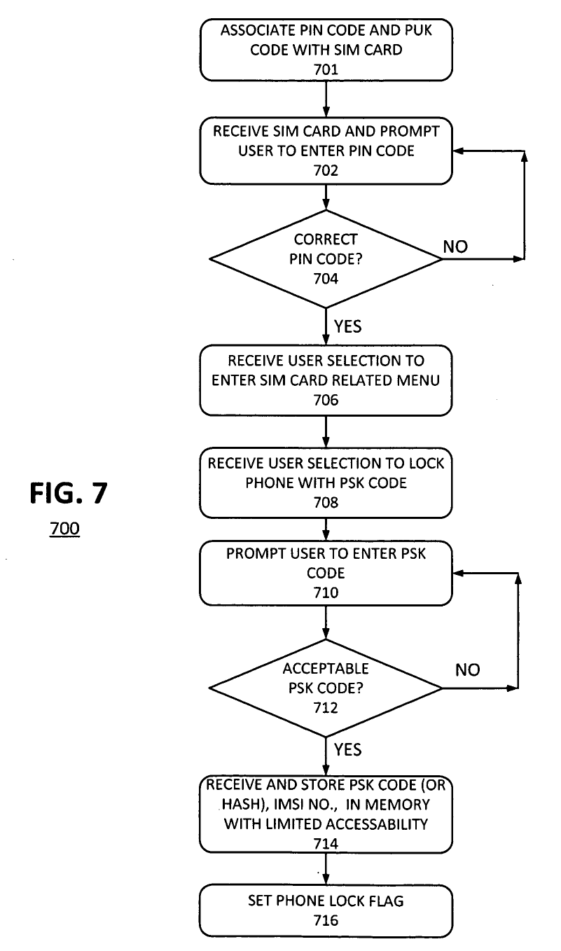

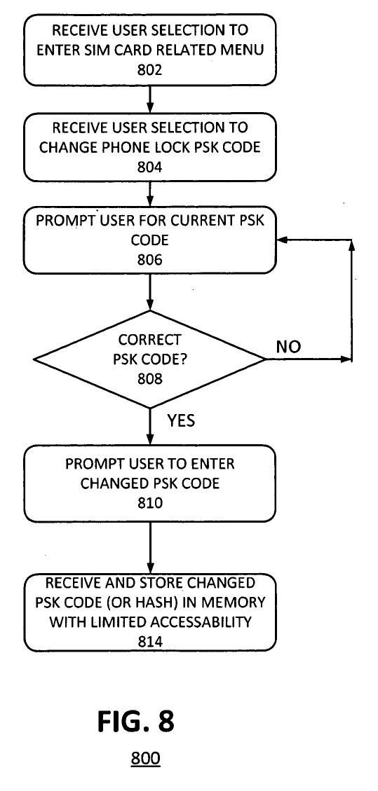

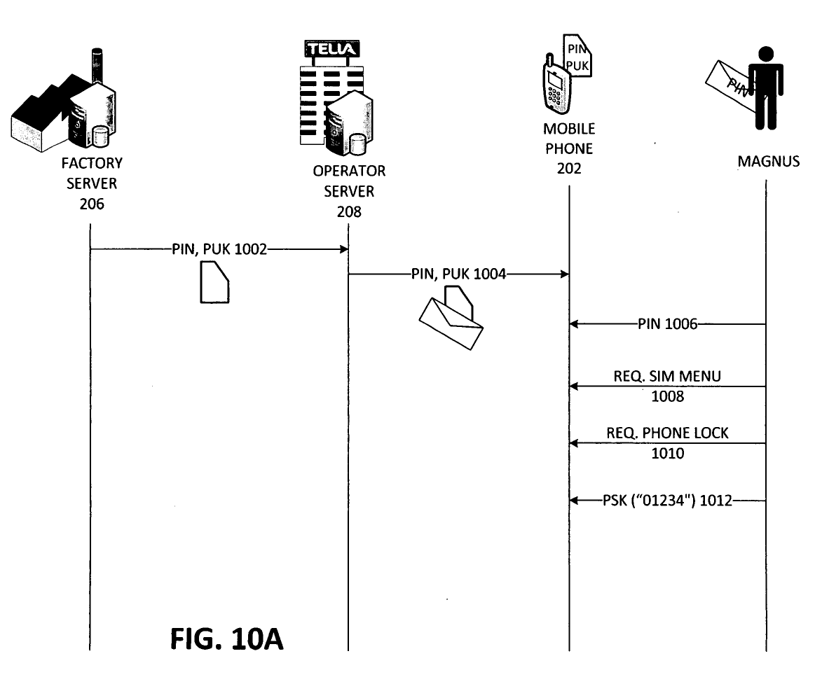

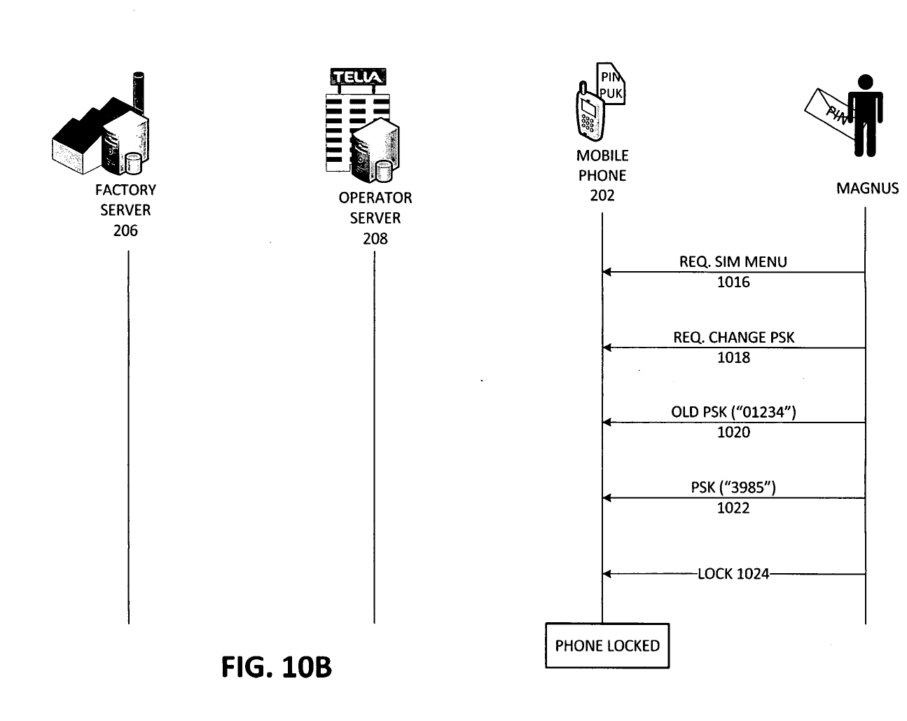

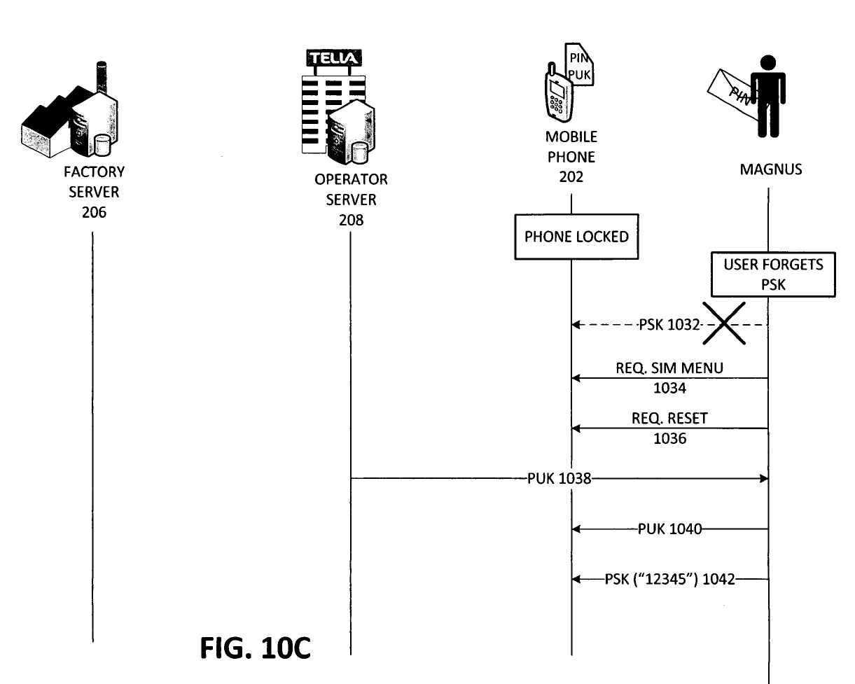

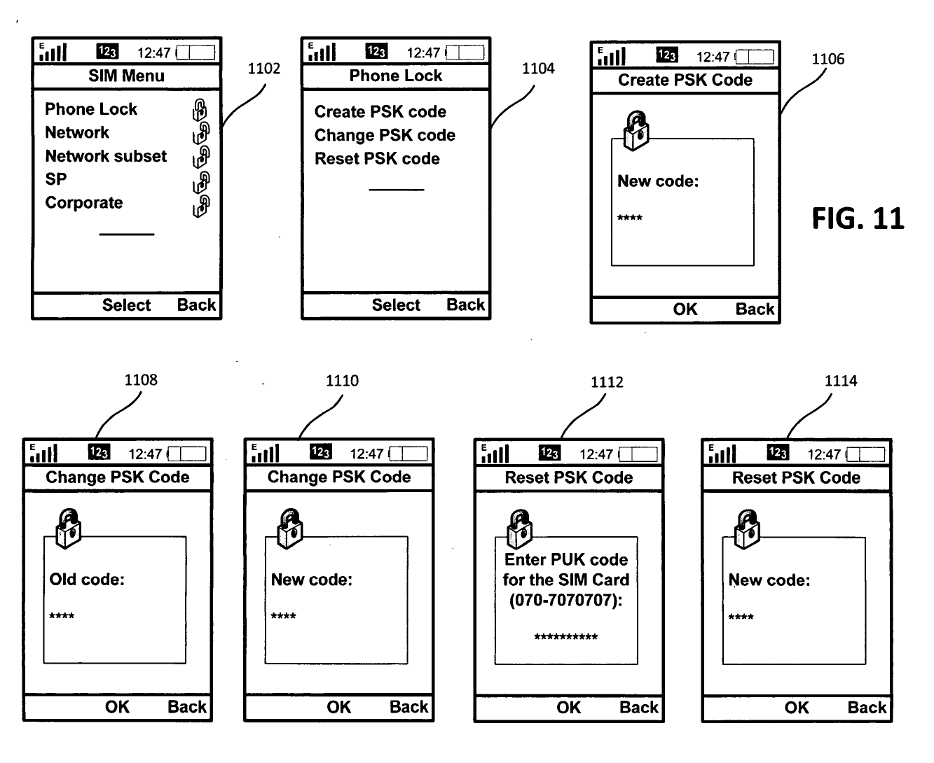

FIGS. 7, 8, 9A, and 9B are flowcharts of exemplary processes 700, 800, and 900A, and 900B for setting, changing, and resetting a PSK code for locking a user device. Processes 700, 800, 900A, and 900B are described with respect to FIGS. 10A, 10B, 10C, and FIG. 11. FIGS. 10A, 10B, and 10C are diagrams of exemplary information passing between devices in network 200. FIG. 11 is a block diagram of exemplary user interfaces that a user may encounter during these processes.

Process 700 is described with the following example. Magnus (a user) travels from Minneapolis, Minn. to Visby, Sweden to visit long-lost relatives. As soon as Magnus arrives, he visits a Telia™ store (e.g., a network operator) to buy a local SIM card to put in his mobile phone 202 that he carried from Minneapolis. The SIM card that he purchases comes in an envelope with the following information printed inside: his new Swedish phone number, a PIN code, and/or a PUK code. As shown in FIG. 10A, the PIN code (or hash) may also be stored in the SIM card (e.g., PIN code area 594 and/or PUK code area 592), which was manufactured at factory 108.

Thus, process 700 may begin with the association of a PIN code and a PUK code with a SIM card (block 701). As shown in FIG. 10A, the PIN and the PUK code may be transmitted from factory server 206 to operator server 208 in message 1002—as well as stored in the SIM card. In one embodiment, the PIN code (or hash) is only stored in the SIM card and not stored in either factory server 206 or operator server 208.

Process 700 may continue when a user device (e.g., mobile phone 202) receives a SIM card and prompts the user for the PIN code (block 702). For example, eager to use his new Swedish phone number, Magnus places the SIM card in mobile phone 202 and turns on his phone. Mobile phone 202 prompts Magnus for the PIN code associated with the SIM card. Requiring entry of the PIN code before allowing the use of the SIM card may help prevent the theft of SIM cards, for example. As requested, Magnus uses keypad 308 to enter the PIN code he received in the envelope with the SIM card from the Telia™ store. Magnus then stores the envelope with the printed PIN code safely in his luggage.

Mobile phone 202 may compare the entered code (or a hash of it) to the PIN code (or hash) stored in the SIM card. If the PIN code is not correct (block 704: NO), then the user may be prompted again for the correct PIN code (block 702). If the PIN code is correct (block 704: YES), then the user may operate the user device with the SIM card.

Magnus may wish to lock mobile phone 202 so that, should he lose it in Visby, nobody would be able to use the phone—with or without his new SIM card inside. In this example, Magnus uses control keys 306 to select a SIM card menu that provides phone locking features as well as other SIM card related features (message 1008). Thus, a selection is received in user device 202 from the user to enter a SIM-card related menu (block 706). In this embodiment, the phone locking features are stored in the SIM card menu so that the user associates the phone locking feature with the SIM card (and, thus, the network operator) rather than the phone manufacturer. That is, because most users associate the SIM card with the network operator (and the user device with a phone manufacturer), displaying the phone lock feature in the SIM card menu may encourage the user to call the operator's customer service when experiencing problems with the feature. In other embodiments, the phone locking feature may be in other menus, some not related to other SIM card features.

Screen 1102 shown in FIG. 11 is an example of a menu related to a SIM card. In particular screen 1102 relates to SIM lock functions, e.g., when the user device is locked to a network operator, a subnet of a network operator, a corporate subnet of a network operator, etc. Screen 1102 also shows a phone lock option.

Magnus then uses control keys 306 to select the “Phone Lock” option of screen 1102, followed by selection of “Create PSK code” of screen 1104 (message 1010). The user device may receive the selection to lock the phone (block 708). The user may be prompted to enter a new PSK code for locking the user device (block 710). For example, Magnus may be prompted with screen 1106 requesting a new PSK code. As shown in FIG. 10A, Magnus enters “01234” as his PSK code (message 1012).

If the new PSK code is not acceptable (block 712: NO) (e.g., it does not conform to a particular format), then the user may be prompted to enter another PSK code (block 710). In one implementation, if the entered code includes alphabetic characters (e.g., a through z), then the code may be considered unacceptable. If the new PSK code is acceptable (e.g., it is a numeric value between 0 and 9999) (block 712: YES), then the PSK code (or hash) may be stored in the memory of the device with limited accessibility (block 714). One such area for storing this information may include extended trim area 552, discussed above, that is not accessible to boot module code, loader code, and/or software being executed in a device coupled to mobile phone 202, but is accessible to the user device's software. Further, in one embodiment, the IMSI number of the SIM card in mobile phone 202 may also be stored in extended trim area 552.

In addition, a flag may be set to indicate that a phone locking PSK code has been set by the user (block 716). In one embodiment, the flag is also stored in part of the memory of the device that has limited accessibility.

Magnus, however, may later decide that a PSK code of “01234” is too easy to guess, and decides to change it. Processes 800 may be implemented for changing the PSK code set in process 700, for example. Magnus may use control keys 306 to access the menu related to SIM card features (message 1016 of FIG. 10B). Thus, process 800 may begin when the user device receives a selection to enter a menu related to the SIM card features (block 802). As mentioned above, screen 1102 is an example of a menu related to a SIM card.

Using control keys 306, for example, Magnus selects the “Phone Lock” option of screen 1102 and “Change PSK code” of screen 1104 (message 1018). The user device may receive a selection to change the PSK code (block 804). As discussed above, in one embodiment, the user enters a menu related to SIM card functions so that the user, Magnus, associates locking the phone (and the PSK code) with the SIM card and his network operator rather than with the phone manufacturer. Thus, should Magnus forget his changed PSK code, he contacts the network operator rather than the phone manufacturer.

The user may be prompted to enter the current PSK code for locking the user device (block 806). For example, Magnus may be prompted with screen 1108 requesting his current PSK code before he is allowed to create a new PSK code. As shown in FIG. 10B, Magnus may enter “01234” as his PSK code (message 1020).

If the PSK code entered is not correct (block 808: NO), then the user may be prompted to enter the current PSK code again (block 806). If the entered PSK code is correct, the user may be prompted to enter a new, changed PSK code (block 810). Screen 1110 is an example of prompting the user for a new, changed PSK code. In this example, Magnus enters four random numbers, e.g., a new PSK code of “3985” (message 1022), into mobile phone 202 as his new, changed PSK code.

Like with process 700, if the changed PSK code is not acceptable, then the user may be prompted to enter another PSK code. If the changed PSK code is acceptable, then the changed PSK code (or a hash) may be stored in the memory of the device with limited accessibility (block 814). Further, in one embodiment, the IMSI number of the SIM card in mobile phone 202 may be stored with the PSK code, so that user device 202 cannot be used without knowledge of the PSK code while the same SIM card is in user device 202. As discussed above, one such memory for storing this information may include extended trim area 552.

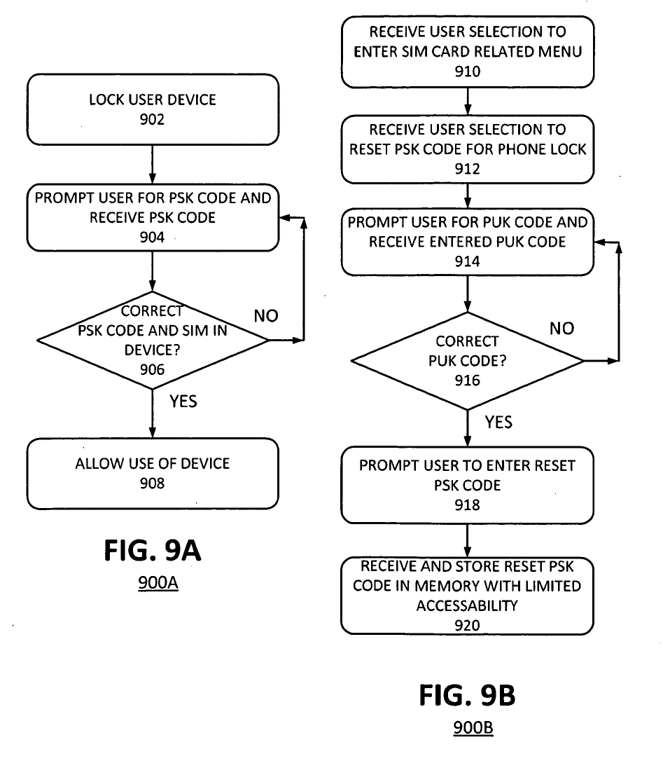

FIG. 9A is an exemplary process 900A for locking and unlocking a user device. At this point, Magnus can use control keys 306 to instruct mobile phone 202 to enter a locked state (block 902) (message 1024 of FIG. 10B), such that mobile phone 202 may prompt the user for the current PSK code (block 904) before allowing use of mobile phone 202. In one embodiment, mobile phone 202 may enter a locked state after a certain period of idle time, when the phone is turned off, or when the phone is turned on.

If, after the user device receives the PSK code (block 904) from the user, and the user device determines that the entered PSK code is not the correct PSK code (block 906: NO), then the user may be prompted to enter the PSK code again (block 904), disallowing use of mobile device 202. If the user enters the correct PSK code (block 906) and the SIM card associated with the PSK code is present in the device (e.g., the SIM associated with the PSK code is in the device), then use of mobile phone 202 may be allowed (block 908).

In one embodiment, to determine whether the entered PSK code is the correct PSK code, user device 202 may compare a hash of the entered PSK code with the value stored in PSK code area 570, which may include a hash of the correct PSK code. Thus, even if the value stored in PSK code area 570 were compromised, the PSK code would not be compromised because it would be computationally infeasible to calculate the correct PSK code from the hash of the correct PSK code.

Use of user device 202 (block 908) may include access by the user to application data 466, which may include private information, such as contact names, phone numbers, and addresses; calendar information; text messages; emails; documents; and web-browsing history and associated usernames and passwords. Use of user device 202 (block 908) may also include use of the device as a communication tool, such as the ability to conduct a phone conversation or send/receive data over a user communication channel. Disallowing use of device 202 may include disallowing all these uses listed above, for example, as a PMP, a gaming device, a GPS device, etc.

In one embodiment, user device 202 may also compare the IMSI number stored in IMSI number area 572 with the IMSI number stored in IMSI number area 596 of SIM card memory 468 to determine whether the SIM card associated with PSK code is present user device 202. In another embodiment, when the PSK code is keyed by the IMSI number, comparing the IMSI number stored in IMSI number area 572 with the IMSI number stored in IMSI number area 596 may be included when checking to determine whether the entered PSK code is correct.

Unfortunately, Magnus may forget his new, changed PSK code. Process 900B is an exemplary process for resetting a PSK code for locking user device. As mentioned, the user device may be locked (block 902) as a result of a user command (e.g., message 1024) or because the user device has been idle for a period of time, for example. Although Magnus enters what he believes to be his current PSK code (message 1032), it is not the correct code. Magnus needs to reset his PSK code to use his own phone.

Magnus uses control keys 306 to access the menu related to SIM card features (message 1034 of FIG. 10C). Thus, in this embodiment, user device 202 receives a selection to enter a menu related to the SIM card features (block 910). As mentioned above, screen 1102 is an example of a menu related to a SIM card. Using control keys 306, for example, Magnus selects the “Phone Lock” option of screen 1102 and “Reset PSK code” of screen 1104 (message 1036). The user device may receive a selection to reset the PSK code (block 912).

The user may be prompted to enter the PUK code associated with the SIM card (block 914). For example, Magnus may be prompted with screen 1112 requesting his PUK code before he is allowed to reset his PSK code. Magnus, however, does not know the PUK code stored in his SIM card. Because Magnus associates the PSK code with the network operator, Magnus contacts the network provider (e.g., Telia) to obtain his PUK code so he can reset his PSK code. Magnus can call the network operator, send an email to the network operator, log into the network operator's web page, etc. Regardless, in one embodiment, the network operator may authenticate Magnus, for example, by requesting the phone number associated with his SIM card (displayed on screen 1112, for example) and by verifying the credit card he used to purchase the SIM card. As discussed above, operator server 208 may store the PUK codes and phone numbers associated with SIM cards, as provided by factory server 206.

If authenticated, the network operator may provide Magnus with the PUK code associated with his SIM card. The network operator may provide Magnus with the PUK code (e.g., as message 1038) via email, phone, fax, web, etc. In response to the prompt (e.g., screen 1112), the user may enter the PUK code received from the network operator (e.g., as message 1040). User device 202 receives the PUK code entered by the user (block 914). In one embodiment, the network operator may charge the user Magnus a fee for providing the PUK code.

If the entered PUK code is not correct (block 916: NO), then the user may be prompted to enter the PUK code again (block 914). If the entered PUK code is correct, the user may be prompted to enter a new, reset PSK code (block 918). In one embodiment, the entered PUK code is determined to be correct by comparing the (hashed) PUK code to the value stored in PUK code area 592. The comparison may be performed by a processor in the SIM card, for example, and an indication of whether the entered PUK code is correct or not may be sent from the PUK code to the user device. Screen 1114 is an example of a screen prompting the user for a new PSK code. Using keypad 308, Magnus enters “12345” (message 1042), into mobile phone 202 as the new, reset PSK code.

Like processes 700 and 800, if the new, reset PSK code is not acceptable, then the user may be prompted to enter another PSK code. If the new, reset PSK code is acceptable, then the new, reset PSK code or a hash of the PSK code may be stored in the memory of the device with limited accessibility (block 920). Further, the IMSI number of the SIM card in mobile phone 202 may be stored with the PSK code, so that user device 202 cannot be used without knowledge of the PSK code while the same SIM card is in user device 202. As discussed above, one such area for storing this information may include extended trim area 552.

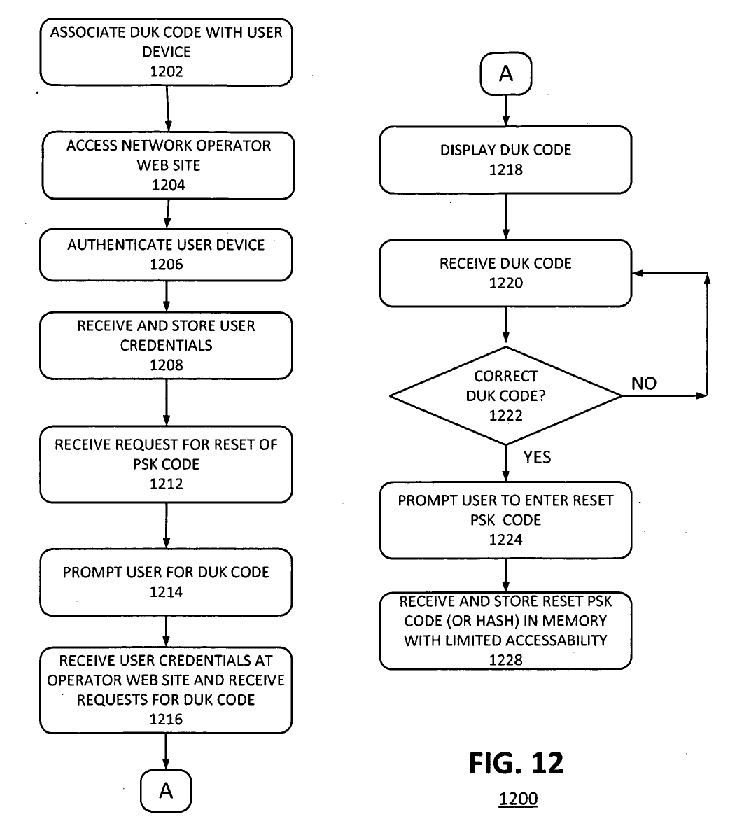

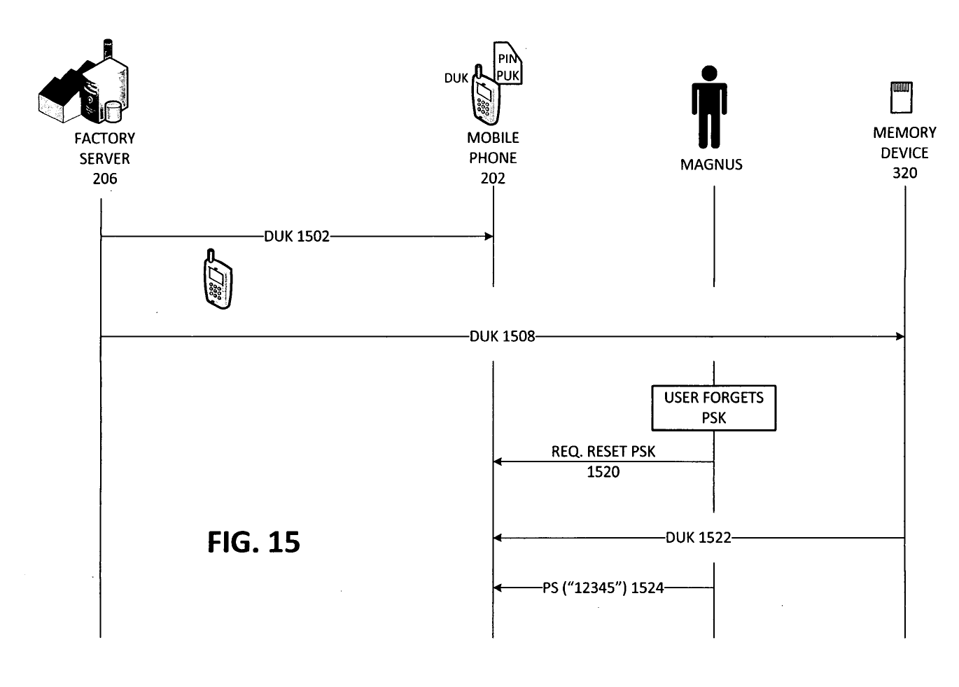

FIG. 12 is a flowchart of an additional exemplary process 1200 for resetting the PSK code for locking a user device. Process 1200 is described with respect to FIG. 15, which is a diagram of exemplary information passing between devices in network 200.

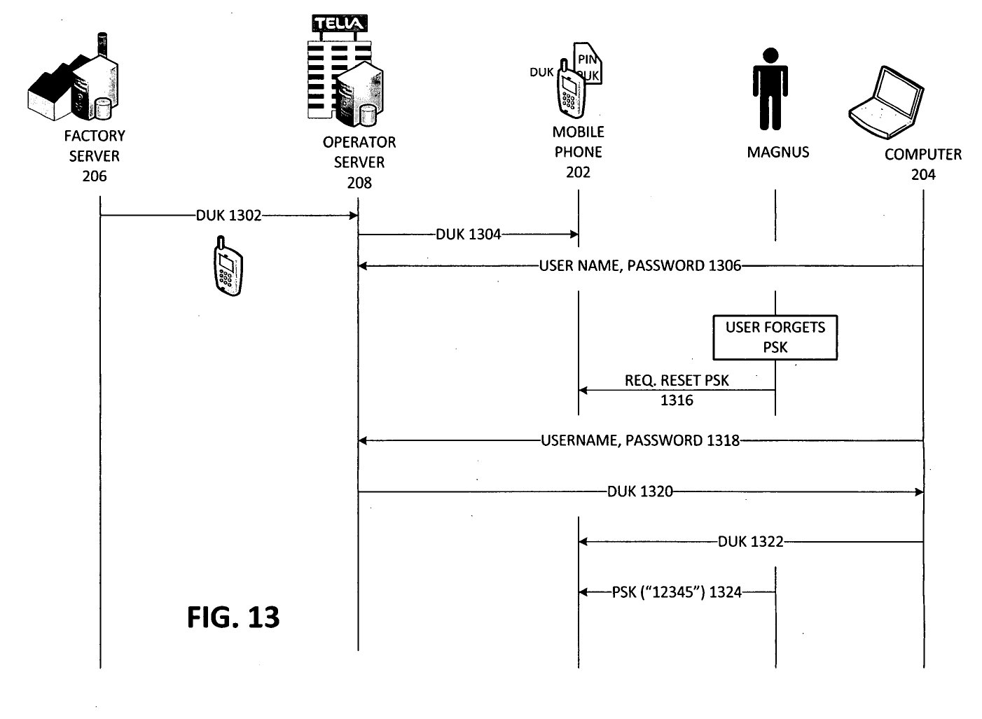

Process 1200 is described with the following example. After arriving in Visby, Magnus also decides to purchase a new mobile phone, as the phones sold in Visby have many more features than the ones sold in Minneapolis. Magnus visits the Telia™ store (e.g., a network operator) to buy a new mobile phone. As shown in FIG. 13, the DUK code is stored in mobile phone 202, which was manufactured at factory 108.

The DUK code for the mobile phone may be transmitted from factory server 206 to operator server 208 in message 1302. Thus, process 1200 may begin with the association of a DUK code with a user device (block 1202). In one embodiment, the DUK code is unique to the user device.

After buying mobile phone 202, Magnus registers his phone by visiting the web site offered by the network operator and, in this example, hosted on operator server 208. The user may access the network operator web site (block 1204). In one embodiment, the user device may be authenticated (block 1206). For example, Magnus may access the network operator web site using mobile phone 202 and it may be authenticated using the DUK code (e.g., mobile phone 202 may send the DUK code (or hash) to the network operator web site). In one embodiment, Magnus authenticates mobile phone 202 by using the serial number of the phone. In one embodiment, Magnus access the web site using computer 204 and may connect mobile phone 202 (e.g., via USB cable) to computer 204. In this case, for example, mobile phone 202 is authenticated by sending the DUK code stored in mobile phone 202 to factory server 208 or by having Magnus enter the serial number of the phone.

Using computer 204, Magnus creates a user name and password for accessing the site, if he does not already have one. Credentials (e.g., a user name and password) may be received and stored (block 1208) by, in this example, network operator in operator server 208. Thus, Magnus may revisit the site again, as long as he remembers his user name and password.

Magnus decides to lock his new mobile phone 202 in case he loses it in Visby and has process 700 performed as discussed above to create a new PSK code for the phone. Unfortunately, Magnus forgets this new PSK also and needs to reset it.

Magnus uses control keys 306 to access a menu related to SIM card features, selects the “Phone Lock” option, and “Reset PSK code.” A request for the reset of the PSK code may be received (block 1212). In this case, the user may be prompted for the DUK code associated with the user device (block 1214). Thus, mobile phone 202 may display a screen, similar to screen 1112, but for the DUK code. Magnus, however, does not know the DUK code, so, using computer 204, he logs into the network operator's web site hosted by operator server 208 (e.g., message 1306 including the user name and password he created in block 1208) and requests the DUK code associated with his phone number (message 1316). The operator web site may receive the user credentials and the request for the DUK code associated with the user device (block 1216).

The operator web site may query a database, such as operator server 208, for the DUK code associated with user device 202. The DUK code may be displayed (block 1218). Magnus reads the DUK code from the screen of computer 204 and, using numeric keypad 308, enters the DUK code into mobile phone 202. The DUK code may be received by the user device (block 1220). In one embodiment, the network operator may charge the user Magnus a fee for providing the DUK code. If the entered DUK code is not correct (block 1222: NO), then the user may be prompted to enter the DUK code again (block 1220). If the DUK code is correct, the user may be prompted to enter a new, reset PSK code (block 1224).

If the new, reset PSK code is not acceptable, then the user may be prompted to enter another PSK code (block 1224). If the new, reset PSK code is acceptable, then the new, reset PSK code (or hash) may be stored in the memory of the device with limited accessibility (block 1228). As discussed above, one such area for storing this information may include extended trim area 552.

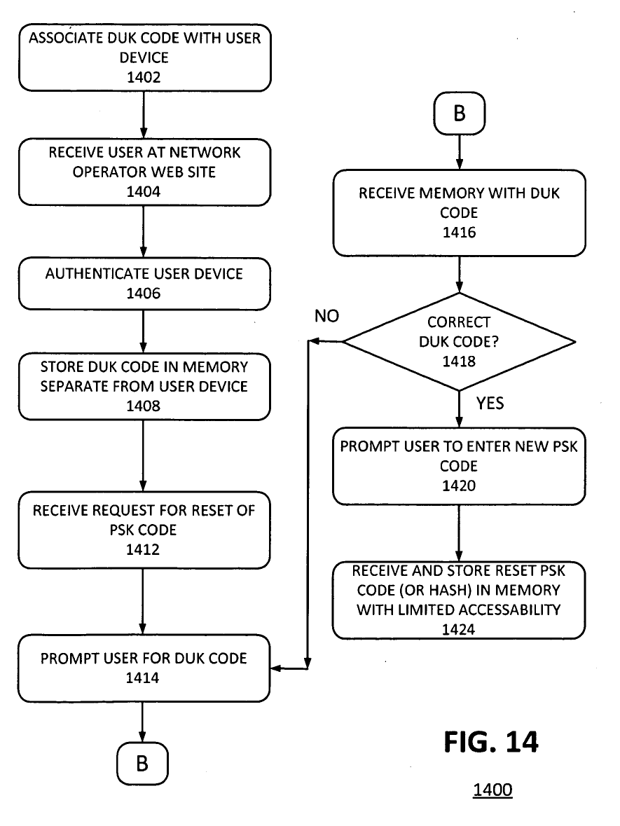

FIG. 14 is a flowchart of an additional exemplary process 1400 for resetting the PSK code for locking a user device. Process 1400 is described with respect to FIG. 15, which is a diagram of exemplary information passing between devices in network 200.

Process 1400 is described with the following example, similar to the example used to describe process 1200. After arriving in Visby, Magnus decides to purchase a new mobile phone. Magnus visits the Telia™ store (e.g., a network operator) again to buy a new mobile phone. As shown in FIG. 15, the DUK code is stored in the mobile phone, which was manufactured at factory 108.

Like process 1200, process 1400 may begin with the association of a DUK code with a user device (block 1402). In one embodiment, the DUK code is unique to the user device. The DUK codes associated with mobile phones are sent from factory server 206 to operator server 208.

After buying mobile phone 202, Magnus may register his phone by visiting a web site offered by the manufacturer of the phone and, in this example, hosted on factory server 206. The user may access the network operator web site (block 1404). In one embodiment, the user device may be authenticated (block 1406). For example, Magnus may access the web site using mobile phone 202 and it may be authenticated using the DUK code (e.g., mobile phone 202 may send the DUK code (or hash) to the web site). In one embodiment, Magnus authenticates mobile phone 202 by using the serial number of the phone. In one embodiment, Magnus access the web site using computer 204 and may connect mobile phone 202 (e.g., via USB cable) to computer 204.

In this embodiment, the DUK code may be stored in Magnus's mobile phone 202 before he locks his new phone and forgets his PSK code. Thus, the DUK code associated with the user device may be stored in a memory device (block 1408). For example, the DUK code associated with mobile phone 202 may be stored in removable memory device 320. Alternatively, the DUK code may be stored in computer 204. In some embodiments, the DUK code may be stored in non-removable memory of user device 202, but this embodiment may not be as secure as other embodiments. In one embodiment, the network operator may charge the user Magnus a fee for providing the PUK code for storage.

Magnus decides to lock his new mobile phone 202 in case he loses it in Visby and has process 700 performed as discussed above to create a new PSK code for the phone. Suppose that Magnus forgets this new PSK also and needs to reset it. Magnus uses control keys 306 to access a menu related to SIM card features, selects the “Phone Lock” option, and “Reset PSK code.” Thus, a request for the reset of the PSK code may be received (block 1412).

Like with process 1200, the user may be prompted for the DUK code associated with the user device (block 1414). In this embodiment, however, Magnus does not have to log into operator server 208 to obtain the DUK code associated with user device 202. Rather, Magnus inserts the memory device (e.g., memory 320) that stores the DUK code into user device 202 (or links user device 202 to the memory device via NFC or USB, for example). In this embodiment, Magnus does not need a current network connection to reset his PSK code.

The memory device storing the DUK code may be received by the user device (block 1416). If the stored DUK code is not correct (block 1418: NO), then the user may be prompted to enter the DUK code again or provide a memory with the DUK code (block 1416). If the DUK code in the memory (or entered) is correct (block 1418: YES), the user may be prompted to enter a new, reset PSK code (block 1420). Screen 1114 is an example of a screen prompting the user for a new PSK code. In this example, Magnus enters “1234” (message 1524), into mobile phone 202 as new, reset PSK code. The new, reset PSK code (or hash) of the PSK code may be stored in the memory of the device with limited accessibility (block 1424). As discussed above, one such area for storing this information may include extended trim area 552.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, in one embodiment, a first PSK code (or a first DUK code) may be stored in primary trim area 550 and a second PSK code (or a second DUK code) may be stored in extended trim area 552. In other words, the PSK code (or DUK code) may be split among primary trim area 550 and extended trim area 552. In this embodiment, the user may be asked to enter the first PSK code during boot loading and the second PSK code when extended trim area 552 becomes accessible. In one embodiment, primary trim area 550 and extended trim area 552 are not simultaneously accessible. Thus, a virus infection of operating system 462 may cause changes to PSK code 570, IMSI number 572, and/or DUK code 576, but not to a PSK code stored in primary trim area 550. In another embodiment, a value indicative of the IMSI number may also be stored in primary trim area 550.

As used herein, an “unblocking code” may include a PUK code and/or a DUK code. As used herein, “comparing” one code to another code (e.g., an entered code to a stored code) may include comparing the one code to the other code directly; comparing a value based on the one code (e.g., a hash of the one code) to the other code; comparing a value based on the one code (e.g., a hash of the one code) to a value based on the other code (e.g., a hash of the other code); or comparing the one code to a value based on the other code (e.g., a hash of the other code).

Additionally, while series of blocks have been described with regard to the exemplary processes 700, 800, 900A, 900B, 1200, and 1400, the order of the blocks may be modified in other implementations. In addition, non-dependent blocks may represent acts that can be performed in parallel to other blocks.

Aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

The term “comprises/comprising,” as used herein, specifies the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A device comprising:
a memory to store a device-lock pass code; and
a processor to:
compare a device-lock pass code entered by a user to the device-lock pass code stored in the memory to determine whether the entered device-lock pass code is correct,
disallow use of the device when the entered device-lock pass code is not correct, and
reset the device-lock pass code stored in the memory based on a comparison of an unblock pass code entered by the user to an unblock pass code associated with a removable identity module.

2. The device of claim 1, wherein the memory further includes:
a boot module and an operating system, wherein the boot module includes instructions for execution by the processor before loading the operating system, and
a memory area not accessible by the boot module, wherein the memory area is accessible by the operating system and the memory area stores the device-lock pass code.

3. The device of claim 2,
wherein the memory area is not accessible by software executed by a processor external to the device; and
wherein the memory area is not accessible by loader code.

4. The device of claim 1, wherein the processor is configured to receive an indication, from the removable identity module, of whether the unblock pass code entered by the user is correct based on the comparison of the pass code entered by the user with the unblock pass code associated with the removable identity module.

5. The device of claim 4, wherein the processor is further configured to:
allow use of the device by the user when the entered device-lock pass code is correct, or
allow use of the device when the entered device-lock pass code is correct and the removable identity module associated with the stored device-lock pass code is present in the device.

6. The device of claim 4, wherein the processor is further configured to:
disallow use of the device when the entered device-lock pass code is correct and the associated removable identity module is not present in the device.

7. The device of claim 6, wherein the processor is further configured to disallow use by
disallowing access to user application data, contact information, calendar information, text messages, email messages, user documents, or web-browsing history; and
disallowing placing or receiving a telephone call.

8. A computer-implemented method comprising:
comparing a device-lock pass code entered by a user to a device-lock pass code stored in a memory of a user device to determine whether the entered device-lock pass code is correct;
disallowing use of the user device when the entered device-lock pass code is not correct;
determining whether an unblock pass code entered by the user is correct based on a comparison of the unblock pass code entered by the user to an unblock pass code stored in and associated with the user device;
resetting the device-lock pass code stored in the memory of the user device when the entered unblock pass code is correct; and
storing a copy of the unblock pass code in a memory device capable of being removably connected to the user device or in a memory of another user device separate from the user device.

9. The computer-implemented method of claim 8, the method further comprising storing the unblock pass code associated with the user device in a non-removable memory in the user device,
wherein the entered device-lock code was entered by connecting the memory device to the user device, and
wherein comparing the unblock pass code entered by the user to the unblock pass code stored in and associated with the user device includes comparing the copy of the unblock pass code to the unblock pass code stored in and associated with the user device.

10. The computer-implemented method of claim 8, further comprising:
allowing use of the user device by the user when the entered device-lock pass code is correct; or
allowing use of the user device by the user when the entered device-lock pass code is correct and a removable identity module associated with the stored device-lock pass code is present in the user device.

11. The computer-implemented method of claim 10, further comprising:
disallowing use of the user device when the entered device-lock pass code is correct and the associated removable identity module is not present in the user device.

12. The computer-implemented method of claim 11, wherein disallowing includes:
disallowing access to user application data, contact information, calendar information, text messages, email messages, user documents, or web-browsing history; and
disallowing placing or receiving a telephone call.

13. A device comprising:
a processor; and
a memory including:
a boot module and an operating system, wherein the boot module includes instructions for execution by the processor before loading the operating system, and
a memory area not accessible by the boot module, wherein the memory area stores a first pass code and is accessible by the operating system,
wherein the processor is configured to:
compare a pass code entered by a user to the first pass code stored in the memory area to determine whether the pass code entered by the user is correct, and
disallow use of the device when the pass code entered by the user is not correct.

14. The device of claim 13,
wherein the memory area is not accessible by software being executed by a processor external to the device; and
wherein the memory area is not accessible by loader code.

15. The device of claim 13,
wherein the first pass code stored in the memory area is associated with a removable identity module, and
wherein the processor is further configured to disallow use of the device when the entered code is correct and the removable identity module is not present in the device.

16. The device of claim 15, wherein the processor is further configured to:
allow use of the device by the user when the pass code entered by the user is correct, or
allow use of the device by the user when the pass code entered by the user is correct and the removable identity module associated with the first pass code is present in the device.

17. The device of claim 15, wherein the processor is configured to disallow use by being configured to disallow access to user application data, contact information, calendar information, text messages, user email messages, user documents, web-browsing history, or a user application.

18. The device of claim 15, wherein the processor is configured to disallow use by being configured to disallow placing or receiving a telephone call.

19. The device of claim 15, wherein processor is further configured to:
reset the first pass code stored in the memory area based on a comparison of the other pass code entered by the user to a second pass code associated with the removable identity module.

20. The device of claim 19,
wherein the second pass code associated with the removable identity module is stored in the removable identity module; and
wherein the removable identity module includes a processor that is configured to compare the other pass code entered by the user to the second pass code associated with the removable identity module to determine whether the entered unblock pass code is correct.
